(19) United States
(12) Patent Application Publication
(10) Pub. No.: US 2005/0282523 A1
(43) Pub. Date: Dec. 22, 2005

(54) Network setting method and program and storage medium thereof

(75) Inventors: Kiyohito Yoshihara, Saitama (JP); Takeshi Kouyama, Tokyo (JP); Hiroki Horiuchi, Saitama (JP); Yoshikazu Fujiza, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/136,555

(22) Filed: May 25, 2005

(30) Foreign Application Priority Data
May 27, 2004 (JP) 2004-157527

(51) Int. Cl. H04Q 7/20

(52) U.S. Cl. 455/411

(57) ABSTRACT

The present invention comprises the steps of performing the network setting for the user equipment by the user equipment itself, sending a discover request message to the respective home network equipment by the user equipment, sending a discover reply message including their own equipment information by the respective home network equipment, performing the specific network setting for the respective home network equipment by the user equipment, setting authentication information to the home network equipment by the user equipment, performing a communication test based on the authentication information by the user equipment and the center server, downloading configuration information corresponded to the authentication information from the center server by the user equipment, and setting the configuration information to the user equipment by the user equipment itself.

### BACKGROUND OF THE INVENTION

1. Field of the Invention

The present invention relates to a network setting method and program, and a storage medium thereof, which automatically perform a network setting required in using various communication services, such as a wireless LAN, E-mail, or a VoIP, for a personal computer as user equipment and a plurality of home network equipment serving to provide an Internet connection, such as an xDSL (xDigital Subscriber Line) modem or a broadband router.

2. Description of the Related Art

In a conventional home network or a small-scale network, a dial-up method for connecting to public lines only when connecting to the Internet has been employed. Patent Document 1 discloses a technique of automatically performing a network setting for an application incorporated in user equipment in such a dial-up connection. Meanwhile, owing to a reduction in the cost of connection fees in recent years, always-on broadband connection services to the Internet at a flat rate have become widespread.

Patent Document 1: Japanese Unexamined Patent Publication No. 2004-32534

The conventional network setting method has had the following technical problems.
(1) In order to establish a broadband Internet connection with the user equipment, performing the network setting only for the user equipment is not sufficient, but is required for all home network equipment, e.g., the broadband router and the xDSL modem, which are connected in series for forming a multistage connection between the user equipment and the Internet. Furthermore, under the condition where a wireless LAN is used, the network setting for both of a terminal and an access point of the wireless LAN must be performed. However, the conventional methods have not been able to automatically perform the network setting for all these home network equipment without omissions.
(2) In order to perform the network setting for the home network equipment from the user equipment, the user equipment must accurately identify the functions and types of the respective home network equipment and the version of the software incorporated therein, and perform the specific network setting according to the identification result. However, according to the conventional methods, it has not been possible for the user equipment to identify the respective home network equipment, so that the automatic network setting to a plurality of the home network equipment with different functions or types has not been able to be performed.
(3) When new home network equipment is added to the network, the network setting must be performed for the new equipment. However, according to the conventional art, the network setting has not been able to be performed automatically for the newly-added home network equipment.
(4) The programs or the various types of software for automatically performing the network setting are generally stored in a CD-ROM and distributed by a telecommunications carrier. However, since the program or software is frequently updated, its version is likely to be old when used by the user. However, according to the conventional art, it has been difficult to obtain the latest version and thus the network setting must be performed using such old program versions, resulting in abnormal settings.

### SUMMARY OF THE INVENTION

An object of the present invention is to provide a network setting method and program, and a storage medium thereof, which automatically and easily performs a network setting for a plurality of existing and newly-added home network equipment with different functions and types, as well as user equipment.

In order to achieve the object, the present invention is characterized by taking the following measures for the network setting method to the respective home network equipment and the user equipment of the network communication system, where the user equipment and at least one home network equipment configure a home network and one of the home network equipment and a center server are connected via a broadband network.
(1) It is characterized by including the steps of: performing the network setting for the user equipment by the user equipment itself; sending a discover request message to the respective home network equipment by the user equipment; returning a discover reply message including their own respective equipment information by the respective home network equipment; performing the specific network setting for the respective home network equipment based on the equipment information included in the detection received discover reply message by the user equipment; setting authentication information in the home network equipment by the user equipment; performing a communication test based on the authentication information by the user equipment and the center server; downloading configuration information corresponded to the authentication information from the center server by the user equipment; and setting the downloaded configuration information to the user equipment by the user equipment.
(2) It is characterized in that the home network includes a plurality of LANs, and that the home network equipment connected to other than a boundary between the home network and the broadband network relays the discover request message while the home network equipment connected to the boundary does not relay the discover request message.
(3) It is characterized in that the home network equipment sends the discover reply message upon detection of its own equipment being newly connected to the LAN, and the user equipment initiates a network setting process in response to the reception of the discover reply message.
(4) It is characterized by including the steps of: notifying the user equipment of a distribution source of the latest version software serving for the network setting or the communication service by the center server; accessing the distribution source notified from the center server and obtaining the latest version software by the user equipment; and installing the obtained software to the target equipment by the user equipment.

According to the present invention, the following effects can be achieved.
(1) The home network equipment on the home network returns the discover reply messages including its own equipment information in response to the discover request message from the user equipment, thereby making it possible for the user equipment to recognize all home network equipment requiring the network setting to be performed. Thus, regardless of the configuration of the home network equipment included in the home network, the network setting for all home network equipment can be performed automatically by the user equipment.
(2) The home network equipment connected to other than the boundary between the home network and the broadband network are made to relay the discover request message while the home network equipment connected to the boundary is made not to relay the discover request message, thereby making it possible for the discover request message to be sent to all home network equipment while preventing the discover request message from being sent to other than the home network, even when the home network includes a plurality of LANs.
(3) Since the home network equipment can also send the discover reply message when it detects its own equipment being newly connected to the LAN, the network setting for the equipment can be performed by simply connecting the home network equipment to the LAN.
(4) The user equipment can easily obtain the latest version software serving to provide the network setting or the communication service, thereby making it possible to always optimize the network connection environment or the status of the communication service by installing the software to the target equipment.

### BRIEF DESCRIPTION OF THE DRAWINGS

FIG. 1 is a block diagram showing a configuration of a main part of a network communication system to which the present invention is applied.

FIG. 2 is flowchart (No.1) showing steps of a “network setting process.”

FIG. 3 is flowchart (No.2) showing steps of a “network setting process.” FIG. 4 is a sequence flow of the “network setting process.”

FIG. 5 is a view showing an example of an initial screen.

FIG. 6 is a view schematically showing a relay control method for a discover request message according to this embodiment.

FIG. 7 is a block diagram showing a configuration of a main part of a home network equipment.

FIG. 8 is a block diagram showing a configuration of a main part of a center server.

### DETAILED DESCRIPTION OF THE PREFERRED EMBODIMENT

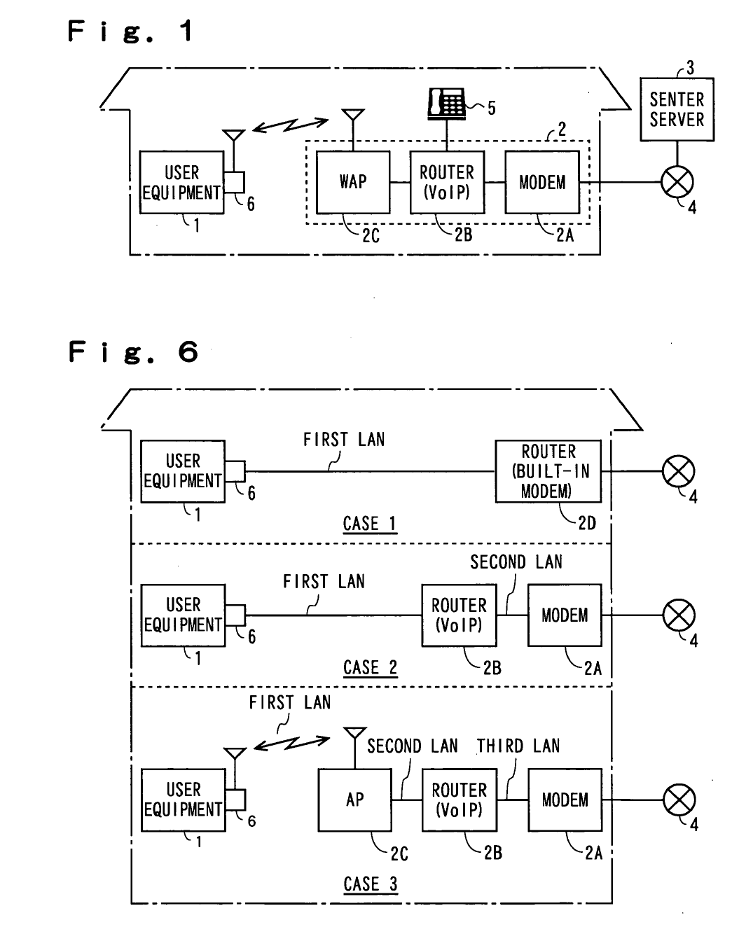

FIG. 1 is a block diagram showing a configuration of a main part of a network system applying the present invention, wherein a user equipment 1 (a client PC) and a home network equipment 2 are interconnected by a LAN to configure a home network, and a center server 3 operated by a telecommunications carrier and the home network equipment 2 are connected via a broadband network 4.

The home network equipment 2, including an xDSL modem 2a and a broadband router 2b, may further include a wireless LAN access point/base station (WAP) 2c. When the broadband router is provided with a VoIP, a telephone set 5 is connected to the broadband router 2b. The user equipment 1 is a personal computer having standard functions including a CD-ROM drive, a LAN board, or an NIC (Network Interface Card), such as a LAN card, and a wireless LAN card 6 is mounted when a wireless LAN is utilized. The respective home network equipment 2a, 2b, and 2c may be either an all-in-one type or a stand-alone type, and in the case of the stand-alone type, each of the home network equipment 2a, 2b, and 2c is connected in series to form a multistage connection by a plurality of LANs.

According to this embodiment, the respective home network equipment 2 and the wireless LAN card 6 are rented or sold to a user by the telecommunications carrier, and a portion of the data required for a “network setting process,” described later, is pre-registered in the respective home network equipment 2. The user has established an account with the telecommunications carrier and already obtained therefrom a CD-ROM containing a network setting program and authentication information (a login ID and a password).

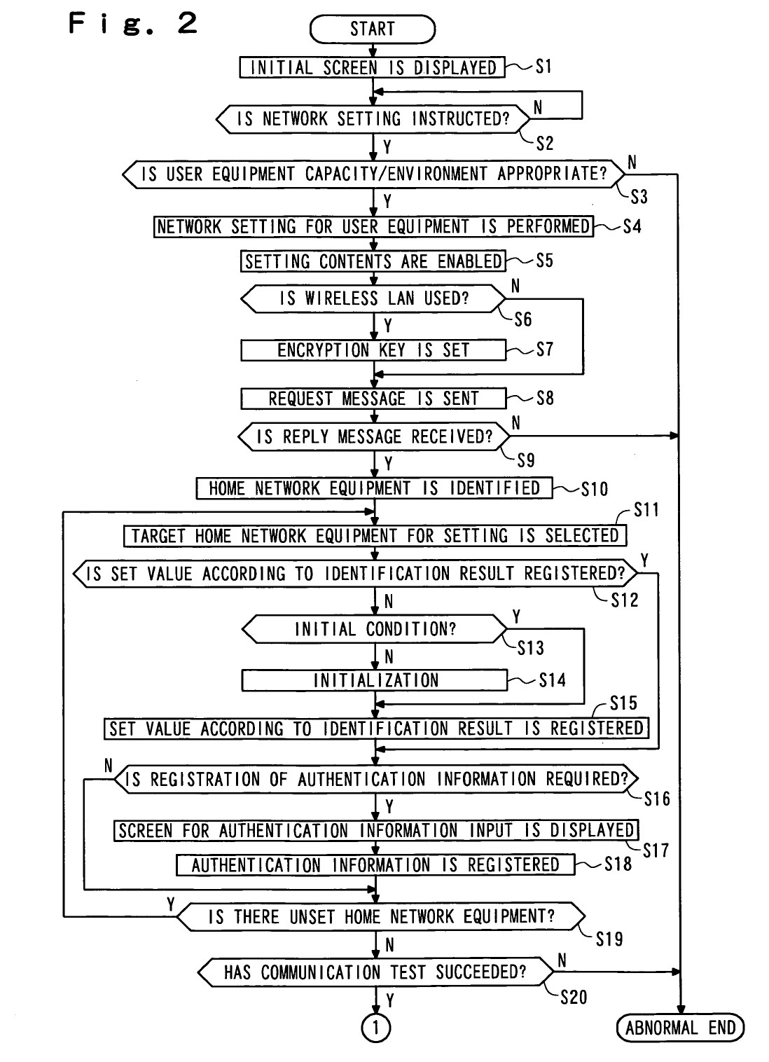

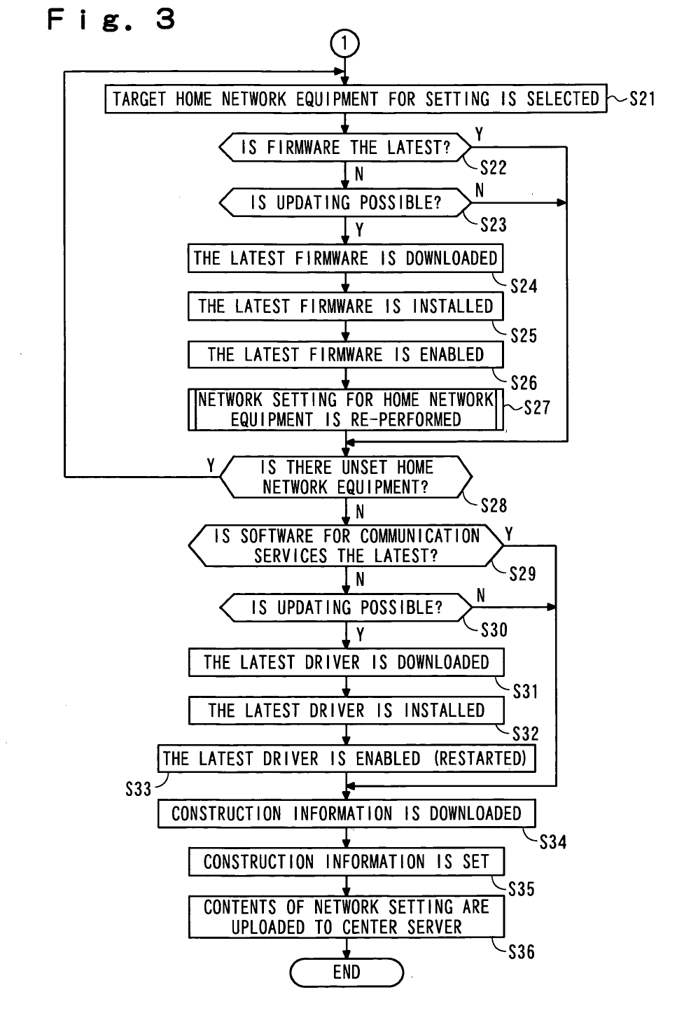

Then, the operation according to the embodiment of the present invention is described in detail with reference to the flowcharts. FIG. 2 and FIG. 3 are the flowcharts showing the steps of the “network setting process” executed according to the network setting program stored in the CD-ROM. FIG. 4 shows the sequence flow thereof. FIG. 2 shows the steps until the communication is established between the user equipment 1 and the center server 3, and FIG. 3 shows the steps for the user equipment 1 to communicate with the center server 3 to perform the network setting for the user equipment 1 itself and the home network equipment 2.

When the CD-ROM is set to the CD-ROM drive of the user equipment 1, the network setting program automatically starts. At step S1, the initial screen appears on the display of the user equipment. FIG. 5 is an example showing the initial screen, which displays a “START” button for the user to select whether to initiate the network setting. When the user clicks on the “START” button at step S2, the process proceeds to step S3. At step S3, it is determined whether the user equipment 1 is provided with the capacity or the environment to execute the program.

Specifically, it is checked for the type or version of an OS (Operating System), a login user and its authority, hardware performance, the free space of a HDD, execution statuses of other programs, the existence/nonexistence of the NIC or the wireless LAN card, the existence/nonexistence of a communication protocol stack such as a TCP/IP, or the existence/nonexistence of an E-mail client software or a web browser as well as their versions.

When the type or version of the OS is not covered, the login user and its authority are inappropriate, the hardware performance is insufficient, the free space of the HDD is insufficient, the other programs are in execution, neither the NIC nor the wireless LAN is incorporated, or the communication protocol stack is nonexistent, it is notified to the user and the program abnormally ends.

Once it is determined that the program can be executed, the process proceeds to step S4 where the network setting is performed for the user equipment 1. Specifically, the automatic acquisition of a DHCP (Dynamic Host Configuration Protocol) or a DNS (Domain Name System) is enabled for an IP address, a subnet mask, a default gateway, and a DNS server address being registered. Furthermore, the existence/nonexistence of the wireless LAN card is checked when the NIC is not detected, and a driver is automatically updated if necessary. The version of the E-mail client software or the web browser is also checked and updated if necessary. An updating application is contained in the CD-ROM along with the network setting program. In the E-mail client software or the web browser, the setting for a dial-up, a proxy, or an SSL (Secure Socket Layer) is enabled or disabled according to the environment. At step S5, the DHCP or the DNS is enabled, and the user equipment 1 is restarted if necessary to reflect the update of the software such as a driver.

At step S6, it is determined whether the wireless LAN is used based on the existence/nonexistence of a LAN cable connection. When the wireless LAN is used, the home network equipment (WAP 2c) 2 is detected by the user equipment 1. In the WAP 2c, a encryption key required for the wireless LAN encryption is preliminarily generated according to the predetermined rules and registered.

According to this embodiment, the encryption key is generated based on a MAC address of the WAP 2c, in which the encryption key generated according to the above rules is preset as a factory default. In the CD-ROM, the rules for generating the encryption key based on the MAC address of the WAP 2c is pre-registered, and at step S7, the user equipment 1 generates and sets the encryption key by assigning the MAC address obtained from the WAP 2c with the rules.

At step S8, a discover request message is sent to all home network equipment 2 connected to the home network. In this message, an address of the user equipment 1 as a source address and a broadcast address as a destination address are registered, along with an identification code meaning the message is the discover request message to be registered.

At step S9, it is determined whether a discover reply message is returned from the home network equipment 2, which has received the discover request message. When no home network equipment 2 is detected, the program abnormally ends, while if at least one home network equipment 2 is detected, the process proceeds to step S10. The discover reply message includes the function, the capacity, and the version of a firmware of the home network equipment which has returned the message being registered as the equipment information. According to this embodiment, the equipment information is registered as a URL (Uniform Resource Locator), where the discover reply message of the home network equipment serving only as the router contains, for example, a following URL (1).
http://192.168.0.4/InternetGatewayDevice.2.1.xml (1)

The address “192.168.0.4” represents the IP address assigned to the home network equipment, “InternetGatewayDevice” represents the function which the home network equipment is provided with (herein, the router), and the subsequent number “1” or “2” represents the version of the firmware or the hardware. Furthermore, if the home network equipment is provided with the VoIP as well as the router, a following URL (2) in addition to the URL (1) is registered.
http://192.168.0.4/InternetGatewayDevice/Device/IGDConfigVoiPService.xml (2)

“IGDConfigVoIPService” indicates that the home network equipment is provided with the VoIP. When the home network equipment is also provided with the wireless LAN, a following URL (3) in addition to the URLs (1) and (2) is registered.
http://192.168.0.4/InternetGatewayDevice/Device/IGDConfigWLANService.xml (3)

“IGDConfigWLANService” indicates that the home network equipment is provided with the wireless LAN.

As described above, according to this embodiment, the discover reply message with only the URL (1) being registered is received from the home network equipment provided with only “the router,” while the discover reply message with the two URLs (1) and (2) being registered is received from the home network equipment provided with “the router” and “the VoIP.” Similarly, the discover reply message with the three URLs (1), (2), and (3) being registered is received from the home network equipment provided with “the router,” “the VoIP,” and “the wireless LAN.” At step S10, the respective home network equipment 2 is identified based on the received equipment information.

According to this embodiment, although the discover request message is sent to all home network equipment 2 even when the home network includes a plurality of LANs, the relay of the message is controlled by the respective home network equipment 2 for the discover request message not being sent to other than the home network.

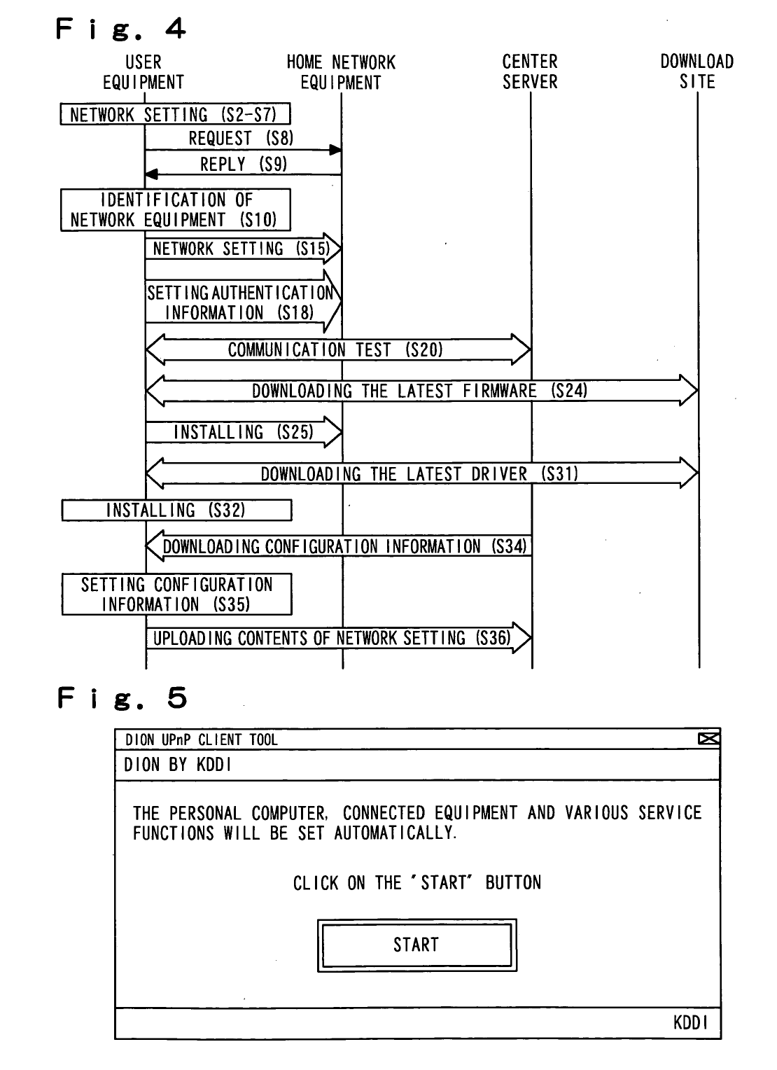

FIG. 6 is a view schematically showing a relay control method for the discover request message according to this embodiment. When considering only the network configuration where the user equipment 1 and a single home network equipment (the modem) 2d are directly connected, as in Case 1, the relay function is not required to be given to the home network equipment 2. However, when considering the network configuration where a plurality of the home network equipment 2 are connected in series for forming the multistage connection via a plurality of LANs, as in Cases 2 and 3, the relay function must be given to the respective home network equipment 2 for making all home network equipment on the home network receive the discover request message. On the other hand, if the relay function is unconditionally given to all home network equipment 2, the discover request message can be sent to even other than the home network causing a workload around the network.

Thus, according to this embodiment, the home network equipment 2 which is disposed at the boundary with the external broadband network 4 and serves as an end terminal of the home network, i.e., the router with the built-in modem 2d of Case 1 or the modem 2a of Cases 2 and 3, is not provided with the relay function, while only the other home network equipment 2 are provided with the relay function. It can be determined whether the home network equipment 2 serves as the end terminal of the home network based on, for example, the existence/nonexistence of a modem function, a specification of a terminated cable, or a format or contents of data transmitted and received through the terminated cable.

Referring again to FIG. 2, at step S11, one of the home network equipment 2 is selected as a target equipment for this time to sequentially perform the network setting for all detected home network equipment 2. At step S12, the target network equipment 2 is referenced by the user equipment 1 to determine whether the specific set value according to the identification result is registered. If the setting has not been performed yet, the process proceeds to step S13 where it is determined whether the equipment 2 is in the initial condition with the predetermined default value being registered. If the default value of the home network equipment has been overwritten by an external operation, etc., it is initialized at step S14. At step S15, the specific set value according to the identification result is read from the CD-ROM and is registered to the home network equipment 2.

At step S16, it is determined whether the registration of the authentication information (the user ID and the password) is required relative to the target equipment 2. If the target network equipment is the router which requires the authentication information being registered, the process proceeds to step S17 where the screen for the authentication information registration is displayed on the user equipment. At step S18, upon inputting the authentication information by the user that operates the user equipment 1, the information is registered to the home network equipment 2. If the target network equipment is the WAP or the modem which does not require the authentication information being registered, the process immediately proceeds to step S19.

At step S19, it is determined whether the network setting has been performed for all detected home network equipment 2. If there remains home network equipment 2 being unset, the process returns to step S11 to repeat each of the above-described processes relative to the next home network equipment. Upon completion of the network setting for all detected home network equipment 2, the communication test between the user equipment 1 and the center server 3 is performed at step S20.

With this communication test, the version of the E-mail client software or the web browser used in the user equipment 1, the version of the driver of the NIC or the wireless LAN card 6 incorporated in the user equipment 1, and the equipment information (including the version of the firmware) of the respective home network equipment 2 are notified from the user equipment 1 to the center server 3.

The center server 3 determines whether each of the versions is the latest based on the notification from the user equipment 1 regarding the type and the version of the application, the type and version of the driver, and the type and version of the firmware. If the versions are other than the latest ones, the user equipment 1 is notified of a distribution source of the latest versions. Upon succession of the above-mentioned communication test, the process proceeds to step S21 in FIG. 3.

At step S21, one of the home network equipment 2 is selected to sequentially update the firmware thereof for all detected home network equipment 2. At step S22, it is determined whether the firmware of the network equipment 2 is the latest version based on the version information notified from the center server 3 in the communication test. If the firmware is not the latest and it is determined that the updating is possible at step S23, then the process proceeds to step S24 to download the latest version by accessing the distribution source notified from the center server 3 in the communication test.

At step S25, the downloaded firmware of the latest version is installed on the network equipment 2 from the user equipment 1. At step S26, the installed latest firmware is enabled by restarting the network equipment 2.

If the contents of the network setting performed before are lost by installing the latest firmware, a part of the processes in FIG. 2 is executed again at step S27 to re-perform the network setting. At step S28, it is determined whether the above-described updating of the firmware is completed for all home network equipment 2. If there remains home network equipment with the updating being not executed, the process returns to step S21 to repeat each of the above-described processes for the equipment while sequentially switching the target equipment.

At step S29, it is determined whether the driver or the software such as an application program used for the provided communication service is the latest version. For example, when the provided communication service is E-mail, the version of the E-mail client software is checked. When the provided communication service is the wireless LAN service, the driver version of the wireless LAN terminal 6 incorporated in the user equipment 1 is checked. If the software is not the latest and it is determined at step S30 that updating is possible, the process proceeds to step S31 where the latest version is downloaded by accessing the distribution source notified from the center server 3 in the communication test.

At step S32, the downloaded software of the latest version is installed to the user equipment 1. At step S33, the user equipment 1 is restarted to enable the installed latest software.

At step S34, configuration information required for the operation of the respective communication services is downloaded from the center server 3 to the user equipment 1, and is set at step S35. For example, if the provided communication service is E-mail, the information such as an SMTP (Simple Mail Transfer Protocol) server name, a POP (Post Office Protocol) server name or an IMAP (Internet Message Access Protocol) server name, a name of a sender, the account, the password, or an E-mail address is automatically set at this stage where the user equipment 1 is made accessible with the center server.

Similarly, if the provided communication service is the VoIP, the information such as a SIP (Session Initiation Protocol) domain name, a SIP URL, a SIP server address, a SIP server port number, a user ID and a password for SIP server authentication, a REGISTER server address, a REGISTER server port number, a city code and own telephone number is set. If the provided communication service is the wireless LAN, an ESSID or the encryption key is set.

When all network settings have been completed as described above, the contents of the network setting of the respective home network equipment 2 and the user equipment 1 are uploaded to the center server 3 at step S36.

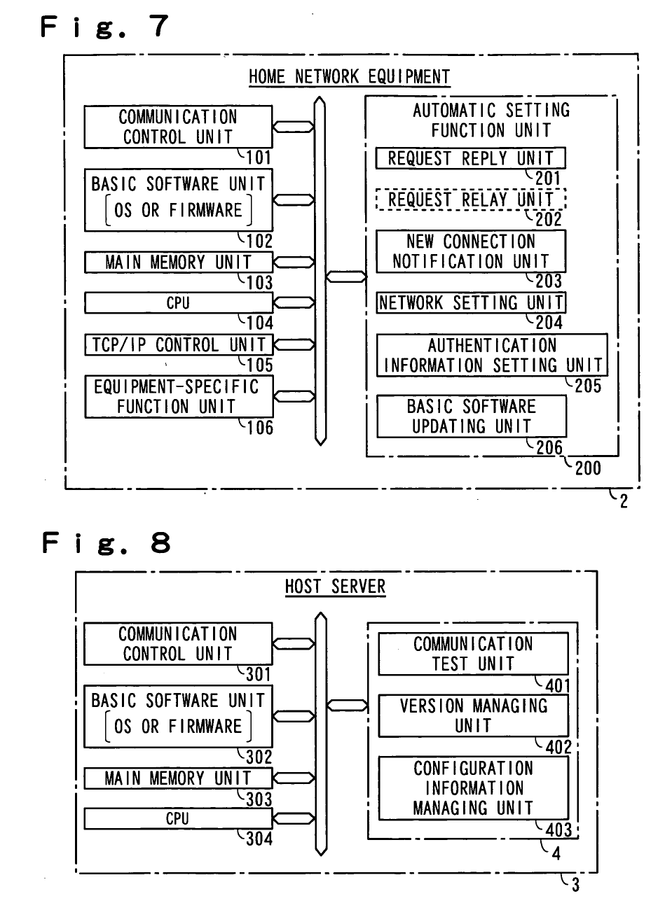

The respective home network equipment 2 are provided with a new connection notification unit (see FIG. 7), thereby, upon detection by their own equipment being newly connected to the LAN, the discover reply message is sent to the LAN regardless of whether it receives the discover request message for discover requesting the user equipment 1 to perform the network setting. The user equipment 1 that has received the message performs the above-described network setting additionally to the newly-connected home network equipment 2.

FIG. 7 is a block diagram showing a configuration of a main part of the home network equipment 2. A communication control unit 101 controls the transmission and receipt of the data and various control signals. A basic software unit 102 stores the OS or the firmware specific to the equipment. A main memory unit 103 provides a work area for a CPU 104 that controls the equipment in accordance with the firmware. ATCP/IP control unit 105 controls the data communication in accordance with the TCP/IP. An equipment-specific function unit 106 controls the operations specific to the equipment, which is provided with a routing table for the route control if the equipment is the router, or provided with an A/D conversion function and a D/A conversion function if it is the modem.

An automatic setting function unit 200 is a function unit that performs the network setting according to the present invention, and a request reply unit 201 returns the discover reply message in unicast to the user equipment 1 in response to the received discover request message. A discover request relay unit 202 performs a function selectively incorporated only in the equipment which is not the end terminal of the home network, such as the WAP 2c or the router 2b, to send (relay) the received discover request message in broadcast. Thus, the function unit is not incorporated in the equipment serving as the end terminal of the home network, such as the modem 2a.

A new connection notification unit 203 returns the discover reply message to the user equipment 1 when the equipment 2 is newly connected to the LAN by itself regardless of whether it receives the discover request message. A network setting unit 204 performs the network setting for the equipment by the remote control of the user equipment 1. An authentication information setting unit 205 is a function unit selectively incorporated in the home network equipment provided with the router function, and sets the authentication information of the user to the equipment by the remote control of the user equipment 1. A basic software updating unit 206 updates the firmware registered in the basic software unit by the remote control of the user equipment 1.

FIG. 8 is a block diagram showing a configuration of a main part of the center server 3. A communication control unit 301 controls the transmission and receipt of the data and various control signals. A basic software unit 302 stores the OS or the firmware specific to the equipment. A main memory unit 303 provides a work area for a CPU 304 that controls the equipment in accordance with the firmware.

An automatic setting function unit 400 is a function unit that performs the network setting according to the present invention, and a communication test unit 401 performs the communication test with the user equipment 1. A version managing unit 402 manages the versions of the driver, the firmware and the various programs such as the applications incorporated in the user equipment 1 or the respective home network equipment 2, while managing the distribution source of the latest version of each software program. A configuration information managing unit 403 manages the configuration information for the communication services that is set to the user equipment 1 or the respective home network equipment 2.

1. A method for performing a network setting for respective home network equipment and a user equipment in a network system, wherein the user equipment and at least one home network equipment configure a home network, and one of the home network equipment and a center server are connected via a network, comprising the steps of:
performing the network setting for the user equipment by the user equipment itself;
sending a discover request message to the respective home network equipment on the home network by the user equipment;
returning a discover reply message including their own equipment information in response to the discover request message by the respective home network equipment;
performing the specific network setting for the respective home network equipment based on the equipment information included in the received discover reply message by the user equipment;
setting authentication information to the home network equipment by the user equipment;
performing a communication test based on the authentication information by the user equipment and the center server;
downloading configuration information corresponded to the authentication information from the center server by the user equipment; and
setting the downloaded configuration information to the user equipment by the user equipment itself.

2. The method for performing the network setting according to claim 1, wherein the home network includes a plurality of LANs, a home network equipment connected to other than a boundary between the home network and a broadband network relays the discover request message, while a home network equipment connected to the boundary does not relay the discover request message.

3. The method for performing the network setting according to claim 2, wherein a home network equipment connected to the boundary is a modem.

4. The method for performing the network setting according to claim 2, wherein a home network equipment connected to other than the boundary is a router.

5. The method for performing the network setting according to claim 4, wherein at least either a wireless LAN access point or a VoIP device is further included as the home network equipment connected to other than the boundary.

6. The method for performing the network setting according to any of claims 1 to 5, comprising the steps of:
notifying the equipment information of the respective home network equipment to the center server by the user equipment;
identifying the respective home network equipment based on the notified equipment information and notifying the user equipment of a distribution source of the latest firmware for the respective home network equipment by the center server;
accessing the distribution source notified from the center server to obtain the latest firmware for the respective home network equipment by the user equipment; and
installing the obtained latest firmware to a target home network equipment by the user equipment.

7. The method for performing the network setting according to any of claims 1 to 5, comprising the steps of:
notifying equipment information of a wireless LAN terminal incorporated therein to the center server by the user equipment;
identifying the wireless LAN terminal based on the notified equipment information and notifying the user equipment of a distribution source of the latest driver for the wireless LAN terminal by the center server;
accessing the distribution source notified from the center server to obtain the latest driver for the wireless LAN terminal by the user equipment; and
installing the obtained latest driver to the user equipment by the user equipment itself.

8. The method for performing the network setting according to any one of claims 1 to 5, wherein the home network equipment sends the discover reply message upon detection of its own equipment being newly connected to the LAN, and
the user equipment initiates a network setting process in response to the reception of the discover reply message.

9. A network setting program that makes the user equipment execute the network setting method according to any of claims 1 to 5.

10. A storage medium of a network setting program wherein the network setting program according to claim 9 is stored in the computer readable form.
